(19) United States
(12) Patent Application Publication
(10) Pub. No.: US 2025/0147331 A1
(43) Pub. Date: May 8, 2025

(54) PRISMATIC COLLIMATING DEVICE

(71) Applicant: BAE SYSTEMS plc, London (GB)

(72) Inventor: Rory Thomas Alexander Mills, Rochester Kent (GB)

(73) Assignee: BAE SYSTEMS plc, London (GB)

(21) Appl. No.: 18/684,343

(22) PCT Filed: Aug. 11, 2022
(86) PCT No.: PCT/GB2022/052095

§ 371 Date: Feb. 16, 2024

(30) Foreign Application Priority Data
Aug. 16, 2021 (EP) 21275114.3
Aug. 16, 2021 (GB) 2111715.5

(51) Int. Cl. G02B 27/30

(52) U.S. Cl. CPC G02B 27/30

(57) ABSTRACT

A prismatic collimating device to collimate image bearing light is disclosed. The prismatic collimating device comprises a first prism and a second prism arranged to receive and collimate a light beam. The first prism comprises an output surface adjacent to an input surface of the second prism. The first prism and second prism are arranged such that the light beam undergoes total internal reflection and refraction at both the output surface of the first prism and the input surface of the second prism. Each of the first prism and second prism comprising at least three optically powered surfaces.

### BACKGROUND

Prismatic collimating devices may be used in displays to provide image bearing light for display to a user.

### BRIEF DESCRIPTION OF DRAWINGS

FIG. 1 illustrates a folded prismatic collimating device according to some examples.

FIG. 2 illustrates the folded prismatic collimating device shown with an illustration of the surfaces having optical power/freeform surfaces.

FIG. 3 illustrates the folded prismatic collimating device with light from three point sources on an image plane.

### DETAILED DESCRIPTION

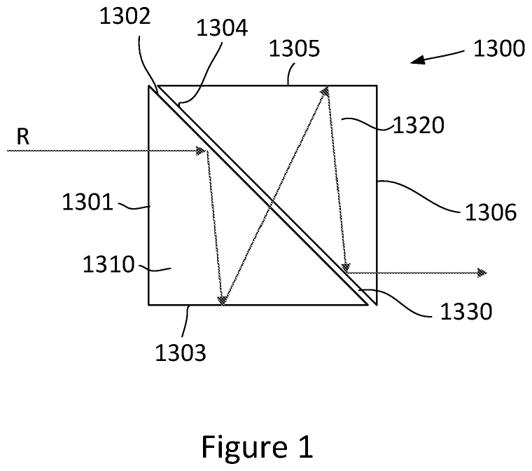

FIG. 1 illustrates a folded prismatic collimating device 1300 according to some examples. The folded prismatic collimating device 1300 comprises a first prism 1310 and a second prism 1320. The first prism 1310 and the second prism are separated by an air gap 1330. For simplicity the first prism 1310 and the second prism 1320 are shown without any surface forms or curvature. However each surface of the first prism 1310 and the second prism 1320 are shaped to have optical power.

Light R interacts with a first surface 1301 of the first prism 1310 and enters the first prism 1310. The first surface 1301 of the first prism 1310 causes the light to undergo refraction towards a second surface 1302 of the first prism 1310. Due to the presence of the air gap 1330 and the angle of incidence of the light, the light that is refracted by the first surface 1301 undergoes total internal reflection (TIR) at the second surface 1302, and is reflected towards a third surface 1303. The third surface 1303 is configured to reflect light received towards the second surface 1302. Due to the angle of incidence, light received from the third surface 1303 at the second surface 1302 is output from the first prism 1310 towards the second prism 1320.

Light output from the first prism 1310 is received by the second prism 1320 at a fourth surface 1304. The light received by the fourth surface 1304 undergoes refraction, and is directed towards a fifth surface 1305. The fifth surface reflects light back towards the fourth surface 1304. Light received at the fourth surface 1304, due to the angle of incidence and the air gap 1330, undergoes total internal reflection, and is directed towards the sixth surface 1306. Light received at the sixth surface 1306 from the fourth surface is output from the second prism 1320.

Due to the optical power of each surface, light may enter the folded prismatic device 1300 and exit collimated. The collimated light may then be directed toward a further optical element and/or towards a user.

In some examples, to aid reflection the third surface 1303 and the fifth surface may be coated with a reflective mirror coating. In some examples at least one of the first surface 1301, the second surface 1302, the fourth surface 1304, and the sixth surface may be coated with an anti-reflection coating. In some examples all of the first surface 1301, the second surface 1302, the fourth surface 1304, and the sixth surface may be coated with an anti-reflection coating.

The first prism 1310 and the second prism 1320 are arranged to receive and collimate a light beam from a light source. As can be seen from FIG. 1, the output surface of the first prism, (i.e. the second surface 1302) is adjacent to the input surface of the second prism (i.e the fourth surface 1304).

The first prism and second prism are arranged such that the light beam undergoes total internal reflection and refraction at both the output surface of the first prism 1310 and the input surface of the second prism 1320. Each of the first prism 1310 and second prism 1320 comprise at least three optically powered surfaces. The optical power is chosen based on the desired properties of the output light and the input light properties in a similar way to the optical power of lenses may be chosen. The surface forms, orientation and material of the prisms may be optimised to achieve the desired output parameters.

Each of the first prism 1310 and the second prism 1320 comprise a surface where the light interacts with the surface twice, and at least two surfaces where the light only interacts once.

In order to allow a small air gap 1330, the surface forms of the second surface 1303 and the fourth surface 1304 may be the same, or substantially the same. However, light that interacts with second surface 1302 the fourth surface 1304 may interact such that one is effectively concave, and the other effectively convex. The surface forms being the same allows the air gap 1330 to be kept constant, and also may reduce the complexity of aligning the prisms.

In some examples the air gap 1330 may be less than 1 mm. In some examples the air gap 1330 may be within a range of 0.25 mm to 0.5 mm. The lower range is based on the tolerance of maintaining the gap. A lower bound for the air gap 1330 may be of order of 100 s of nm, as below 100 s of nm issues like interference or evanescent coupling may occur. The size of the air gap may also be dictated by the overall size of the device where a smaller device requires a smaller air gap.

In some examples the first prism 1310 and the second prism 1320 may have a substantially triangular cross-section.

FIG. 1 shows the folded prismatic collimating device 1300 receiving a single ray of light R from a single source (not shown). However, this is for ease of viewing the Figure. It is to be understood that the folded prismatic collimating device may be configured to receive light from any number of light sources. In some examples the light sources may comprise point light sources. The drawings illustrate the light source as comprising three point light sources (e.g. P0, P1, P2) however this is merely for ease of viewing. In some examples the light source comprises a plurality of sources, which may be arranged as an array of point sources. Sets of sources within the plurality of sources may correspond with particular colours. For example a first set of light sources in an array may provide green light, whereas a second and third set in the array may provide blue and red light respectively.

In some examples the folded prismatic collimating device 1300 may output a light beam having a common exit pupil in both a vertical and horizontal axis. In some examples the folded prismatic collimating device 1300 may output a light beam having an uncommon exit pupil in a vertical and horizontal axis, such that the light beam that is output has a different waist point for the vertical and horizontal axis.

In some examples the first prism 1310 and the second prism 1320 may be bonded together, for example by an adhesive. The air gap 1330 may be replaced by a bonding layer or another low refractive index coating.

In some examples, the prisms may comprise alignment features, to reduce the complexity of aligning the prisms.

In some examples, the at least one of the first surface 1301, second surface 1302, third surface 1303, fourth surface 1304, fifth surface 1305 and sixth surface 1306 may have a surface form substantially defined by at least one of: a spherical surface definition, an aspheric surface definition, a biconical surface definition, or a high order polynomial definition. In this context high may mean an order of ten or more.

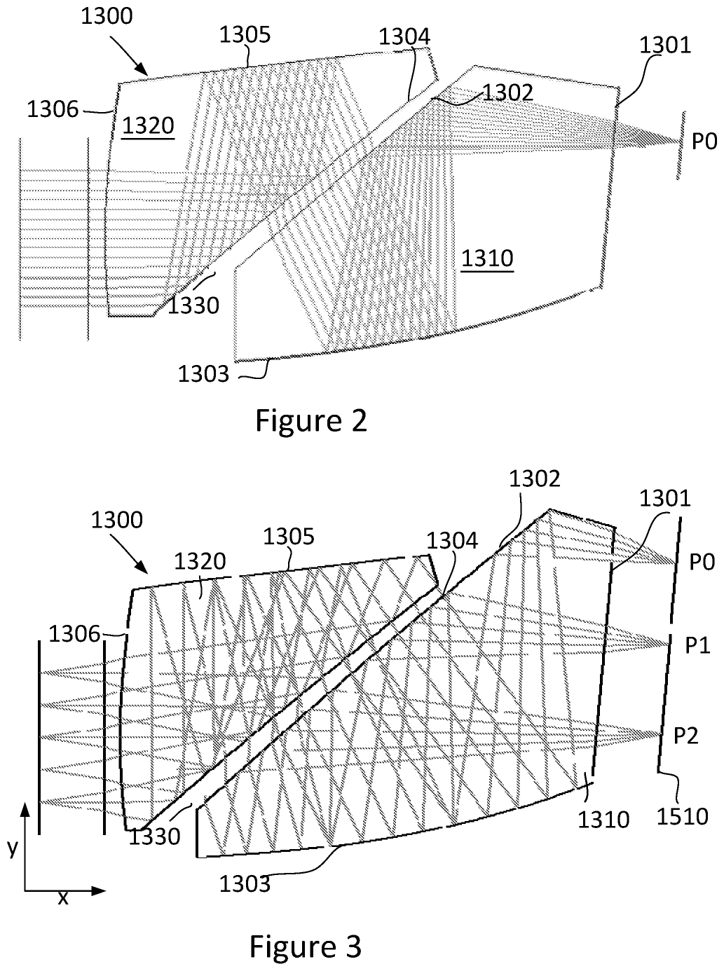

FIG. 2 illustrates the folded prismatic collimating device 1300, however unlike FIG. 1 it is shown with the surfaces having optical power/freeform surfaces and also shows more ray traces. Light entering the folded prismatic collimating device 1300 is shown from a single point source P0 for ease of viewing, however as stated above any number of light sources may be used.

FIG. 3 illustrates the folded prismatic collimating device 1300 with light from three point sources P0, P1, P2 on an image plane 1510. Unlike FIG. 2, FIG. 3 shows the exit pupil comprising a FOV in the y axis of the folded prismatic collimating device 1300. The FOV in the y axis is the main factor in the height of the folded prismatic collimating device 1300. Similarly, a FOV in the x axis of the image is the main factor in the width of the folded prismatic collimating device 1300.

A high order polynomial may be a polynomial with at least 10 terms.

1. A prismatic collimating device to collimate image bearing light, the prismatic collimating device comprising:
a first prism and a second prism;
the first prism comprising a first surface, a second surface, and a third surface,
the first surface configured to receive and refract image bearing light, from an image source, towards the second surface,
the second surface configured to reflect light by total internal reflection, the light received from the first surface, towards the third surface, and refract light received, from the third surface, towards the second prism, and
the third surface configured to reflect light received, from the second surface, towards the second surface; and
the second prism comprising a fourth surface, a fifth surface, and a sixth surface,
the fourth surface configured to receive and refract light, received from the third surface, towards the fifth surface, and reflect light by total internal reflection, the light received from the fifth surface, towards the sixth surface,
the fifth surface configured to receive light, from the fourth surface, and reflect towards the fourth surface, and
the sixth surface configured to receive and refract light, providing a collimated output, received from the fourth surface;
wherein the first surface, second surface, third surface, fourth surface, fifth surface, and sixth surface are optically powered, and an air gap is provided between the second surface and the fourth surface.

2. The prismatic collimating device according to claim 1, wherein the first prism and the second prism have a substantially triangular cross-section.

3. The prismatic collimating device according to claim 1, further comprising a light source comprising a set of point sources.

4. The prismatic collimating device according to claim 1, wherein an exit pupil of collimated output comprises common coordinates in a horizontal axis and a vertical axis.

5. The prismatic collimating device according to claim 1, wherein an exit pupil of the prismatic collimating device has common coordinates in only one of a horizontal axis and a vertical axis.

6. The prismatic collimating device according to claim 1, wherein the air gap size is less than 1 mm.

7. The prismatic collimating device according to claim 1, wherein the second surface and the fourth surface have a substantially similar surface form.

8. The prismatic collimating device according to claim 1, wherein at least one of the first surface, second surface, and third surface have a substantially similar surface form to at least one of the fourth surface, fifth surface, and sixth surface.

9. The prismatic collimating device according to claim 1, wherein at least one of the first surface, second surface, fourth surface, and sixth surface is coated with an anti-reflection coating.

10. The prismatic collimating device according to claim 1, wherein the first prism and the second prism comprise one or more alignment features.

11. The prismatic collimating device according to claim 1, wherein at least one of the first surface, second surface, third surface, fourth surface, fifth surface, and sixth surface has a surface form substantially defined by at least one of: a spherical surface definition, an aspheric surface definition, a biconical surface definition, or a high order polynomial definition.

12. The prismatic collimating device according to claim 1, wherein the second surface is configured to reflect light received from a first range of angles, and transmit light received from a second range of angles, wherein the first range of angles and the second range of angles have substantially zero overlap.

13. The prismatic collimating device according to claim 1, wherein the fourth surface is configured to reflect light received from a third range of angles, and transmit light received from a fourth range of angles, wherein the third range of angles and the fourth range of angles have substantially zero overlap.

14. A prismatic collimating device to collimate image bearing light, the prismatic collimating device comprising:
a first prism and a second prism arranged to receive and collimate a light beam, wherein the first prism comprises an output surface adjacent to an input surface of the second prism, and the first prism and second prism are arranged such that the light beam undergoes total internal reflection and refraction at both the output surface of the first prism and the input surface of the second prism, and each of the first prism and second prism comprises at least three optically powered surfaces.

15. The prismatic collimating device according to claim 14, wherein:
the first prism comprising a first surface, a second surface, and a third surface,
the first surface configured to receive and refract image bearing light, from an image source, towards the second surface,
the second surface is the output surface of the first prism and configured to reflect light by total internal reflection, the light received from the first surface, towards the third surface, and refract light received, from the third surface, towards the second prism, and
the third surface configured to reflect light received, from the second surface, towards the second surface; and
the second prism comprising a fourth surface, a fifth surface, and a sixth surface,
the fourth surface is the input surface of the second prism and configured to receive and refract light, received from the third surface, towards the fifth surface, and reflect light by total internal reflection, the light received from the fifth surface, towards the sixth surface,
the fifth surface configured to receive light, from the fourth surface, and reflect towards the fourth surface, and
the sixth surface configured to receive and refract light, providing a collimated output, received from the fourth surface.

16. The prismatic collimating device according to claim 15, wherein the first prism and the second prism have a substantially triangular cross-section.

17. A prismatic collimating device to collimate image bearing light, the prismatic collimating device comprising:
a first prism and a second prism arranged to receive and collimate a light beam, wherein the first prism comprises an output surface adjacent to an input surface of the second prism, and an air gap is provided between the output surface and the input surface, and the first prism and second prism are arranged such that the light beam undergoes total internal reflection and refraction at both the output surface of the first prism and the input surface of the second prism, and each of the first prism and second prism comprises at least three optically powered surfaces.

18. The prismatic collimating device according to claim 17, wherein the first prism and the second prism have a substantially triangular cross-section, and the air gap size is less than 1 mm.

19. The prismatic collimating device according to claim 17, wherein:
the output surface is configured to reflect light received from a first range of angles, and transmit light received from a second range of angles; and
the input surface is configured to reflect light received from a third range of angles, and transmit light received from a fourth range of angles.

20. The prismatic collimating device according to claim 19, wherein the first range of angles and the second range of angles have zero overlap, and wherein the third range of angles and the fourth range of angles have zero overlap.
